(19) United States
(12) Patent Application Publication
(10) Pub. No.: US 2017/0019962 A1
(43) Pub. Date: Jan. 19, 2017

(54) LED Circuit With Multiple Switch Configurations

(71) Applicant: Luminaire LED, Inc., Edison, NJ (US)

(72) Inventor: Ronald Lipson, Edison, NJ (US)

(73) Assignee: LUMINAIRE LED, INC., Edison, NJ (US)

(21) Appl. No.: 14/801,697

(22) Filed: Jul. 16, 2015

(51) Int. Cl. H05B 33/08

(52) U.S. Cl. CPC H05B 33/0815

(57) ABSTRACT

An LED dimmer circuit has a constant current source, a dual pole, dual throw (DPDT) switch and two arrays of LEDs. In one position of the DPDT switch, the arrays are in series; in the other position the arrays are in parallel. When the arrays are connected in series, all the current from the constant current source flows through both arrays and illumination is high. When the arrays are in parallel, the current from the constant current source equally divides. The one or more printed circuit boards may use one constant current source when the DPDT switch is in one position and a different constant current source when the DPDT switch is in another position.

### BACKGROUND

Light emitting diodes (LEDs) are semiconductor devices that use a p-n junction as a source of light. LEDs behave in a manner similar to conventional diodes. When a positive voltage is applied to the p-side of the p-n junction, holes are driven away from the p-side and across the p-n junction. Likewise, electrons in the n-side are attracted across the junction toward the p-side. When electrons collide with holes, they recombine and emit a quantity of light known as a photon. The color of light is determined by the band gap of the semiconductor material. White color LEDs are made by coating a blue LED with a phosphor that converts the blue light into a mixture of green, yellow and red. The human eye perceives the mixture as white and makes LEDs possible as source of general illumination.

LEDs consume only a fraction of the energy required to power incandescent or fluorescent lights. LEDs also have higher illumination and potentially longer lives than either incandescent or fluorescent lamps. However, LEDs are more expensive and require special circuits for dimming. Because of their power saving feature, many authorities that regulate construction of commercial and industrial facilities require new facilities to have arrays of LEDs for general illumination, especially illumination in areas that require only occasional lighting, such as warehouses, stairwells, or individual rooms. Entire arrays of LEDs can be turned on and off with simple switches or switches with motion or proximity sensors. Certain areas often require a constant minimal amount of illumination and a higher amount when a person or a vehicle enters a given area. Such areas would benefit from a dimming control.

Unlike conventional fixtures and luminaires for incandescent and fluorescent lamps, LED luminaires are pre-fabricated with all lamps (LEDs) installed on a printed circuit board. A printed circuit board is a non-conductive substrate that mechanically supports electrical or electronic elements and provides conductive paths to connect the electrical and electronic elements. For LED luminaires, the LEDs are arranged in fixed, parallel series arrays. In such arrays there are multiple sets of LEDs. Each set includes a number of LEDs arranged in parallel with each other and the sets are connected in series. Each luminaire also requires a power supply. Typical power supplies provide fixed, constant currents at 350 mA or 700 mA. The magnitude of the constant current is determined in advance by the level of illumination expected from the LED luminaire. A power supply that provides a different constant current would not provide the same illumination output. As a practical matter, each LED luminaire is designed for only one level of constant current and if a power supply is more or less than the designed constant current, the LED luminaire will not perform as expected.

Known manufacturing practices provide fixed configurations of LEDs that are wired together on a printed circuit board. Each fixed, wired configuration of LEDs will operate optimally with only one predetermined constant current. A manufacturer must produce a large number of different fixed configurations of LEDs to meet the needs of different customers. However, each configuration is optimized for one constant current power supply. For example, a printed circuit board with a fixed configuration of LEDs designed to accept a power supply of 350 mA will not optimally operate at a different current level. Varying the current will change the output illumination of the luminaire.

It would be desirable to have flexibility so that different power supplies could be used with the same printed circuit board of pre-wired LEDs. Since customers may require different drivers for different illumination needs, it would be very desirable to have configurable arrays of LEDs that could be altered to accept different drivers. Such arrays would dramatically reduce the inventory of printed circuit boards a supplier would need to satisfy the different demands of a customer. Power supplies often vary in price and availability. Manufacturers would like the flexibility to use alternate power supplies for the same printed circuit board so that less expensive or more available power supplies could be swapped for expensive or scarce power supplies, even though the supplies had different constant current outputs. If manufacturers had a single printed circuit board that could accept two or more power supplies, they would make large gains in reducing their inventory of fixed configurations of printed circuits with pre-wired LEDs.

In addition, customers may be unsatisfied with the level of illumination provided by an array. Different customers may find the same array too bright or too dim and would like to alter the brightness of the array after it is installed. Other customers require variable illumination. Dimming controls for incandescent lights are relatively simple and inexpensive, but dimming controls for LEDs can be a problem. It is possible to use dimming circuits that have voltage sources with linear current regulators for driving LEDs, but such circuits are inefficient and waste electricity. For example, U.S. Publication No. 2003/0102819, describes the problem with resistance dimming and suggests solving the problem with a pulse-width modulated power supply. That solution requires complex circuitry and its modulator wastes energy. Nevertheless, pulse-width modulators have been accepted by many for dimming LEDs. See, e.g., U.S. Pat. Nos. 7,906,915 and 6,864,461.

Another dimming circuit is shown in U.S. Pat. No. 6,737,814. It suggests voltage controlled dimming in combination with a threshold switch circuit. U.S. Pat. No. 6,737,814, observes that LEDs in series have a different dimming characteristic compared to LEDs in parallel. The dimming circuit has two sets of two LEDs. Each set has its two LEDs in series. A switching circuit configures the two sets of LEDs into either a series connections of four LEDs or into two parallel sets of series LEDs. The switching circuit is controlled by a voltage divider and diode that establish a voltage threshold for switching between four LEDs in series and two parallel sets of two LEDs in series. The dimming characteristic is a combination of the individual series and parallel luminance characteristics as modified by voltage of the voltage divider.

Others advise that a series resistor be included with each LED in arrays of LEDs that are connected in parallel in order to limit the current through the LED in case the operating voltage varies. However, such a circuit results in wasted energy because the resistors consume electrical energy as heat and that detracts from the savings possible with LEDs that have little or no on resistance.

It would be desirable to have a less complex, less expensive, and more efficient dimming circuit.

It would also be desirable to eliminate series resistors from arrays of parallel LEDs that are used for general lighting because such resistors waste energy by converting it into heat instead of light.

It would be desirable to have a single printed circuit board that carried all the components for powering and dimming LEDs used for general illumination.

It would also be desirable to have configurable arrays of LEDs that could use different power supplies depending upon the configuration of the LED arrays.

It would further be desired to have on one printed circuit board arrays of LEDs that could be reconfigured prior to or after installation to have multiple configurations or different energy consumption or levels of illumination.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments include a circuit for dimming a plurality of light emitting diodes. The circuit has a constant current source, two arrays of LEDs, and a double pole, double throw (DPDT) switch for alternately connecting the two arrays in series with each other or in parallel with each other. When the DPDT switch connects the arrays in series, the same current flows in each array. When the DPDT switch connects the arrays are in parallel, current splits into equal amounts for each array.

In one embodiment having two arrays, the first array is configured to have sets of parallel diodes connected in series. More specifically, the first array has a first plurality of sets of diodes. The diodes in each of the first plurality of sets are connected in parallel with each other and the sets of first plurality of diodes are connected in series. The second array is similarly arranged and has a second plurality of sets of diodes. The diodes in each of the sets of the second plurality of diodes are connected in parallel with each other and the sets of the second plurality of diodes are connected in series.

Other embodiments with different arrays are possible. In some embodiments, the arrays will have the same configuration. The parallel series array of sets of LEDs is one example. An alternate array configuration includes sets of series connected diodes, where the series connected diodes are in parallel with each other. Still other embodiments may have combinations of arrays of different configurations.

Further embodiments include three or more arrays and multiple switches instead of a DPDT switch to alternately establish series and parallel connections among the arrays. When the diodes in an array are in their on-state, the total effective resistance of all arrays should be approximately the same. Where the same configuration is used for all arrays and each array has the same number of diodes, the current divides equally among the parallel connected arrays because the effective input resistance of the diodes in their on-state is small enough to be negligible. Each identically configured array presents the same input resistance to the constant current source and current divides equally among the parallel connected arrays. Variations in the input on resistances of the diodes are minimized by using LEDs sorted from the same production run and having substantially the same forward voltage drop.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a conceptual schematic of an embodiment with two arrays;

FIG. 2 is a detailed schematic of an embodiment with two arrays;

FIG. 3 is a detailed schematic of an alternate embodiment with two arrays;

FIG. 4 is a schematic of another embodiment with two arrays; and

FIG. 5 is a schematic of an alternate embodiment with three or more arrays.

### DETAILED DESCRIPTION

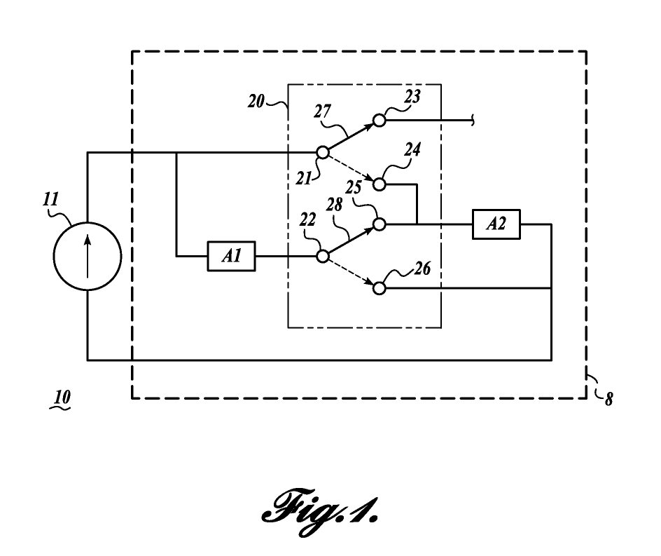

FIG. 1 is a conceptual schematic diagram that illustrates the features of one embodiment. It shows a circuit 10 with a DC current source 11 and a printed circuit board (PCB) 8. The PCB 8 holds LED arrays A1 and A2. LEDs are current-driven devices and although they have a non-liner current-voltage characteristic, over a range of normal operation their illumination is proportional to their current. A constant current source 11 will vary its output voltage, but will provide a relatively constant current. In final assembly, the constant current source may be attached to the PCB 8. A double pole, double throw (DPDT) switch 20 selectively connects the arrays in series or in parallel with the current source 11. In one position, the DPDT switch connects arrays A1, A2 in series and the same current flows in both arrays. If the LEDs are properly sourced from the same production run and are of equal input impedance, then the voltage drop across each array is the same. In its alternate selective position, the DPDT switch 20 connects the arrays A1, A2 in parallel and the constant current splits evenly between the two arrays. When the arrays A1, A2 are in parallel, each array will carry about half the current it carried while in its series connection. When the LEDs are forward biased and in their on-state, the individual resistance of each LED is minimal and may be ignored.

The circuit 10 has a number of advantages. It allows a manufacturer to provide a single printed circuit board with arrays of diodes that may be configured when the final power source and the illumination for the luminaire are known. As will be shown later, a manufacturer may prepare printed circuit boards with two arrays A1, A2 and a DPDT switch and delay adding a power supply until a customer specifies the application. With the DPDT switch, the printed circuit board may be configured to use a standard 25 watt constant current source that supplies 350 mA at between 36 and 72 volts for 25 watts or a constant current source that supplies 700 mA of current between 18 and 36 volts. The 25 watt 350 mA source will power the arrays A1, A2 in their serial or parallel configuration and the 700 mA will also power the arrays in their serial configuration. As such, the manufacturer will have one printed circuit board that can accept one of two power sources, thereby reducing the need for separate printed circuit boards for different power sources.

Another feature of circuit 10 is that one may throw the DPDT switch 20 to change illumination 50%. Illumination may be reduced to lower power consumption, thereby saving electrical energy. The DPDT switch 20 may be controlled by a motion sensor (not shown). Upon sensing motion, switch 20 changes from a low level to a high level (series-connected) when a person enters the illuminated area. A separate timer (not shown) may operate the DPDT switch to return the configuration to its lower (parallel) illumination if no motion is detected for a predetermined amount of time.

The DPDT switch 20 has two inputs 21, 22 and four outputs, 23-26. In the circuit 10, the input 21 is coupled to a first switch arm 27 and the input 23 is coupled to a second switch arm 28. In the position shown in FIG. 1, the inputs 21, 22 are connected to the first and third outputs 23, 25 to thereby connect the LED arrays A1 and A2 in series. Outputs 24 and 26 are left open. In their selected, alternate positions shown by dashed lines, the inputs 21, 22 are connected to the second and fourth outputs 24, 26 in order to connect the LED arrays A1 and A2 in parallel. Outputs 23 and 25 are left open.

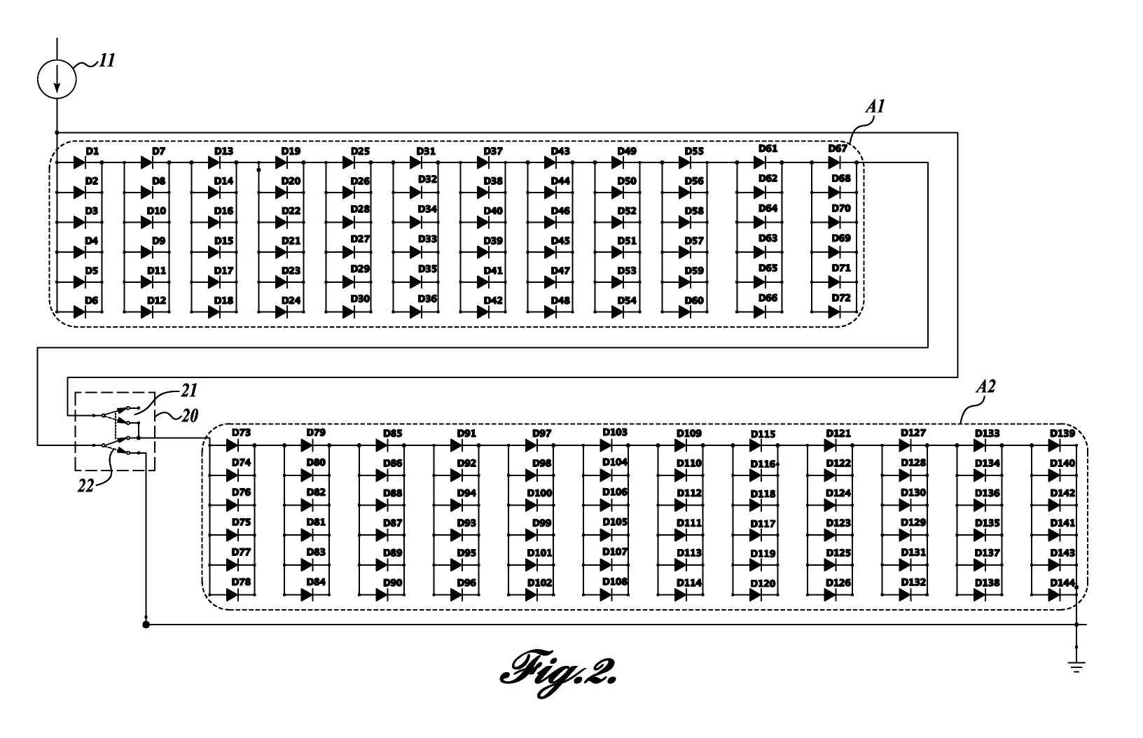

FIG. 2 shows two 6×12 arrays, A1, A2 of diodes. In each array, there are 12 sets of six diodes. Each set of six diodes has its diodes connected in parallel and the sets are in series. Accordingly, each set of six diodes carries the same total current as all other sets in its array. This parallel/series arrangement has advantages. If one diode in a parallel set of six diodes fails (e.g., open circuit), the remaining active diodes in the set will still carry the same total current, but the current will be shared by five diodes instead of six. In other words, each of the five active diodes will carry one-fifth of the total current for the set, rather than the usual one-sixth of the total current. The set of five active diodes will be slightly brighter than the other sets of six active diodes, but the failure of one diode will not interrupt the general illumination provided by the other sets of diodes.

When the DPDT switch 20 is in the selected alternate position shown in FIG. 2, the two arrays A1, A2 are in parallel. Accordingly, the constant output current of current source 211 splits. Each array A1, A2, has half the current output from the current source 211. In the selected alternate position shown in dashed lines, arrays A1, A2 and the 24 sets of six parallel diodes are connected in series. For purposes of explanation, assume that the constant current source outputs 350 mA and outputs between 36 and 72 volts. When the two arrays A1, A2 are in series, all the 24 sets of six diodes are connected in series, each set carries the total current of 350 mA, and each diode in each set carries one-sixth of the total current of 58.3 mA. The voltage across each set is approximately 3 volts (72 v/24), large enough to turn on each diode in each set. When the two arrays A1, A2, are in parallel, the 350 mA output current of the constant current source splits substantially equally between the two arrays A1, A2, so that each array carries 175 mA, the sets are in series so each set carries 175 mA, and each of the six diodes in each set diode carries 29.2 mA. The voltage across each set is also 3.0 volts (36 v/12), large enough to turn on each diode in in each set. As explained above, the illumination (lumen output) of each LED is proportional to current through the LED. It follows that the illumination is reduced almost 40% by switching between a series connection of arrays A1, A2 and parallel connection of arrays A1, A2.

However, if the arrays are switched to their parallel configuration, a 700 mA constant current source will provide the same illumination as the 350 mA supply with the series connected arrays. Each array will receive 350 mA and the resulting illumination will be the same as the series connected array that used a 350 mA constant current source. The manufacturer has the advantage of using either a 350 mA or 700 mA constant current source for the same PCB 8.

The constant current source supplies enough voltage to turn on all the LEDs. When the arrays A1, A2 are connected in series, there will be 24 identical forward voltage drops to turn on each diode in each set of six parallel diodes. Accordingly, the constant current source must supply at least 24×2.85 (FVD of one diode) for a total voltage of about 68.4 volts. In the alternate position for the DPDT switch of FIG. 2, the arrays A1, A2 are in parallel and each array has the same total voltage drop or 12×2.85 volts=34.2 volts. As mentioned above, the 350 mA power supply outputs between 36 and 72 volts and meets the voltage requirement for each setting of DPDT switch 20.

In embodiments shown and described, the LEDs have a forward voltage drop of 2.85 volts with a commercial range of +/−50 millivolts. At one time LEDs had forward voltage drops that varied extensively. When such LEDs were used in general illumination applications, they required individual testing and sorting into groups of closely related forward voltage drops and often special circuits were needed to maintain forward biases of the LEDs. However, manufacturing of LEDs has matured and most suppliers deliver LEDs in large quantities with substantially uniform forward voltage drops of 2.85 volts. It is recommended that all LEDs in an array be chosen from the same manufacturing run. In their forward conducting state, the LEDs may carry between 50 mA and 100 mA and have a maximum rating of 180 mA. A margin of safety is provided by operating the LEDs at currents significantly less than their maximum rating.

The current source 11 is a standard off-the-shelf driver. It provides a constant current and adjusts its output voltage within a specific range to drive a load at a constant current. Such drivers have built-in circuitry to guard against inrush currents in excess of rated current, short circuits, and reverse polarity that can damage or destroy LEDs. The current source 11 will provide a wide range of voltage to maintain the selected drive current. For example, one commercial driver is available in a 25 W version. The version will supply 350 mA at between 36 and 72 volts. Another version commercially available will supply 700 mA at 50 watts and 72 volts. Accordingly, a feature of the embodiments described herein, allows a manufacturer to use a 700 mA or 350 mA drivers with the same board, thus reducing inventory of SKU numbers and allow for greater flexibility in driver selection.

When the arrays A1, A2 are connected in parallel with each other, they act as current splitters and substantially equally divide the current from the constant current source into two equal currents so that the total current in each array is the same.

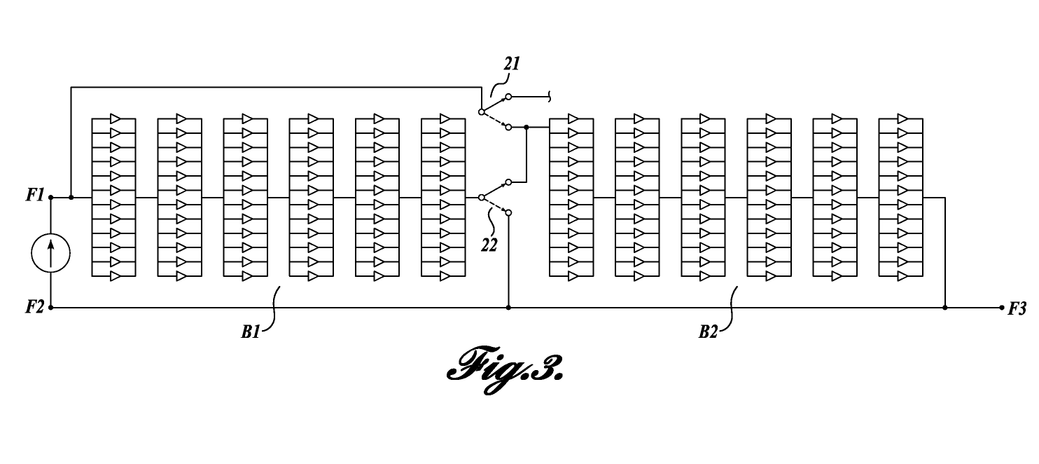

In other embodiments, the arrays may comprise larger sets of 12 parallel diodes per set where the sets are connected in series. Exemplary arrays B1, B2 of such 12×6 arrays are shown in FIG. 3. Arrays B1, B2 each has six sets of 12 diodes per set where the diodes in each set are in parallel.

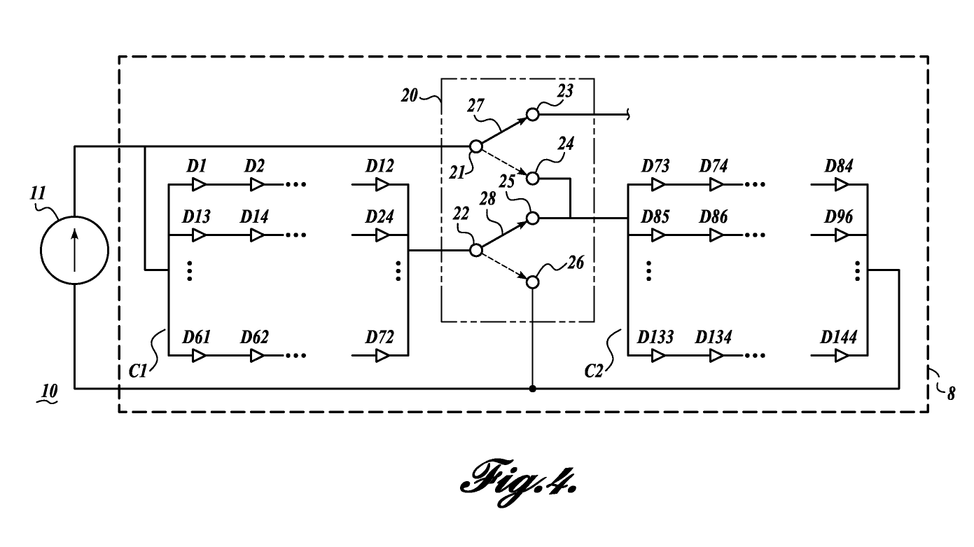

In other embodiments, the arrays may comprise sets of diodes where the diodes in each set are connected in series and the sets are connected in parallel. An example is shown in FIG. 4 with arrays C1, C2 where each set has 12 diodes in series and the six sets in each array are in parallel.

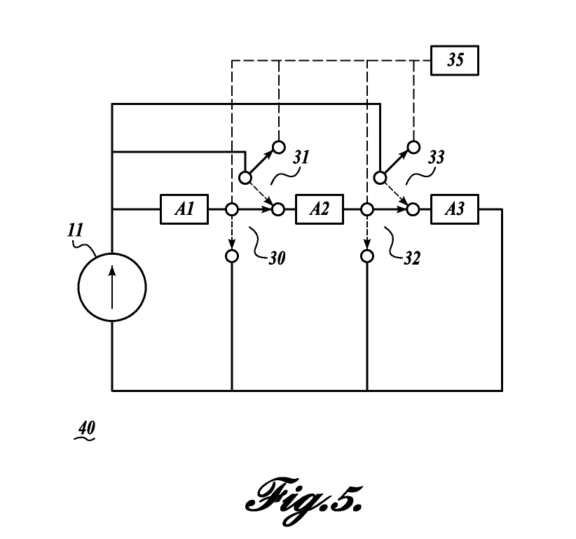

Other embodiments include three or more arrays. In such embodiments, each array has the same number of diodes so that the current from the constant current source will split equally into the arrays. If there is any major variation in the total on resistance of any one array, one or more ballast resistors may be added to the array so that the total resistance for each array in its on-state is the same and current divides equally among the arrays. An exemplary embodiment is shown in FIG. 5. Circuit 40 has three arrays A1, A2, A3, that are connected in series to constant current source 11 by array switches 30-33. A master switch 35 operates the individual switches 30-33 to move each switch arm to its alternate position shown by a dashed arrow. In a selected, alternate position of the master switch, the arrays A1, A2, A3 are connected in parallel. Those skilled in the art understand that the master switch 35 and the array switches 30-33 may be constructed as relays or semiconductor devices arranged on a printed circuit board with the current source 11 and suitable lead routings in solder or other metal leads to establish the functional connections shown in FIG. 4.

In other embodiments, the DPDT switch may be replaced by well-known DIP switches. A DIP switch is a manual electric switch that is packaged with other switches in a group in a standard dual in-line package (DIP). The term “DIP switch” may refer to each individual switch, or to the unit as a whole. DIP switches are used on printed circuit boards to customize the connections between electronic components on the board. By suitable use of DIP switches, the arrays may be configured in series or in parallel.

Specific details of the embodiments of the present disclosure are set forth in the description and in the figures to provide a thorough understanding of these embodiments. A person skilled in the art, however, will understand that the invention may be practiced without several of these details, or that additional details can be added to the invention. Well-known structures and functions have not been shown or described in detail to avoid unnecessarily obscuring the description of the embodiments of the present disclosure.

The details of the embodiments were described in connection with a single printed circuit board, but the scope of the claims includes implementing the embodiments on one or more circuit boards and interconnecting the boards for control by the recited switches. Those and other mechanical embodiments of the described circuits are deemed within the spirit and scope of the appended claims.

Unless the context clearly requires otherwise, throughout the description and the claims, the words “comprise,” “comprising,” and the like are to be construed in an inclusive sense, as opposed to an exclusive or exhaustive sense; that is to say, in the sense of including, but not limited to. Additionally, the words “herein,” “above,” “below,” and words of similar connotation, when used in the present disclosure, shall refer to the present disclosure as a whole and not to any particular portions of the present disclosure. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

While illustrative embodiments have been illustrated and described, it will be appreciated that various changes can be made therein without departing from the spirit and scope of the invention.

The embodiments of the invention in which an exclusive property or privilege is claimed are defined as follows:

1. A circuit for selectively configuring a plurality of light emitting diodes, comprising:
first and second arrays of light emitting diodes; and
a double pole, double throw (DPDT) switch connected to the first and second arrays of light emitting diodes, said DPDT switch having a first position for selectively connecting the first and second arrays of diodes in series with each other and a second position for selectively connecting the first and second arrays of diodes in parallel with each other.

2. The circuit of claim 1 wherein the first array of diodes comprises first sets of diodes, wherein the diodes in each first set are connected in parallel with each other and wherein the first sets of diodes are connected in series with each other.

3. The circuit of claim 2 wherein the second array of diodes comprises second sets of diodes, wherein the diodes in each second set are connected in parallel with each other, and wherein the second sets of diodes are connected in series with each other.

4. The circuit of claim 1 wherein the first array of diodes comprises first sets of diodes, wherein the diodes in each first set are connected in series with each other, and wherein the first sets of diodes are connected in parallel with each other.

5. The circuit of claim 4 wherein the second array of diodes comprises second sets of diodes, wherein the diodes in each second set are connected in series with each other, and wherein the second sets of diodes are connected in parallel with each other.

6. The circuit of claim 1 wherein the second array of diodes comprises second sets of diodes, wherein the diodes in each second set are connected in series with each other, and wherein the second sets of diodes are connected in parallel with each other.

7. The circuit of claim 1 wherein the DPDT switch further comprises two inputs, wherein the first input of the switch is connected to one end of the first array and the second input of the switch is connected to the other end of the first array.

8. The circuit of claim 7 wherein the DPDT switch further comprises four outputs, wherein a first output of the switch is left open, a second and a third output are connected to the one end of the second array, and the fourth output is connected to the other end of the second array.

9. The circuit of claim 8 wherein the DPDT switch further comprises two switch arms moveable together to connect the first and second inputs to the first and third outputs or to the second and fourth outputs, respectively.

10. The circuit of claim 1 wherein the input on resistance of the first array is the same as the input on resistance of the second array.

11. The circuit of claim 1 wherein the number of diodes in the first array is the same as the number of diodes in the second array.

12. A circuit for selectively configuring a plurality of light emitting diodes (LEDs), comprising:
one or more printed circuit boards for holding LEDs and having traces for connecting one or more LEDs in series or in parallel with other LEDs;
two or more arrays of light emitting diodes, each array comprising one or more sets of LEDs; and
switches connected to the two or more arrays and configured to selectively alternatively operate to connect the arrays in series and in parallel with each other.

13. The circuit of claim 12 wherein one or more arrays comprise sets of diodes, wherein the diodes in each set are connected in parallel with each other and the sets of diodes are connected in series with each other.

14. The circuit of claim 12 wherein one or more arrays comprise sets of diodes, wherein the diodes in each set are connected in series with each other and the sets of diodes are connected in parallel with each other.

15. The circuit of claim 12 wherein all the arrays comprise sets of diodes, wherein the diodes in each set are connected in parallel with each other and the sets of diodes are connected in series with each other.

16. The circuit of claim 12 wherein all the arrays comprise sets of diodes, wherein the diodes in each set are connected in series with each other and the sets of diodes are connected in parallel with each other.

17. The circuit of claim 12 wherein at least one array comprises sets of diodes, wherein the diodes in each set are connected in parallel with each other and the sets of diodes are connected in series with each other, and wherein at least one other array comprises sets of diodes, wherein the diodes in each set are connected in series with each other and the sets of diodes are connected in parallel with each other.

18. A circuit for configuring a plurality of light emitting diodes, comprising:
a constant current source;
first and second arrays of light emitting diodes,
wherein said first array has a first plurality of sets of diodes, wherein the diodes in each of the first plurality of sets of diodes are connected in parallel with each other, and wherein the first plurality of sets of diodes are connected in series,
wherein said second array has a second plurality of sets of diodes, and
wherein the diodes in each of the second plurality of sets of diodes are connected in parallel with each other and wherein the second plurality of sets of diodes are connected in series; and
a double pole, double throw (DPDT) switch connected to the constant current source and to the first and second arrays of light emitting diodes, said DPDT switch having a first position for selectively connecting the first and second arrays of diodes in a series with each other and a second position for selectively connecting the first and second arrays of diodes in a parallel with each other.

19. A configurable LED circuit comprising:
one or more substrates for supporting circuits;
input terminals on the substrates for connecting to a power supply;
first and second arrays of light emitting diodes (LEDs) connected to the substrates and selectively connectable to each other; and
means for alternately connecting the first and second arrays of LEDs in series and in parallel.

20. The configurable LED array of claim 19 wherein the means for alternately connecting the first and second LED arrays in series and in parallel comprise a double pole, double throw (DPDT) switch.

21. The configurable LED array of claim 19 wherein the means for alternately connecting the first and second LED arrays in series and in parallel comprises two or more DIP switches.

22. The configurable LED array of claim 19 wherein the means for alternately connecting the first and second LED arrays in series and in parallel comprises two or more relay switches and master switch coupled to said relay switches.

23. The configurable LED array of claim 19 wherein the substrates comprise one or more printed circuit boards.
